(19) United States
(12) Patent Application Publication
(10) Pub. No.: US 2025/0321765 A1
(43) Pub. Date: Oct. 16, 2025

(54) SYSTEMS AND METHODS FOR AUTOMATED UI LAYOUT

(71) Applicant: CANON U.S.A., INC., Melville, NY (US)

(72) Inventor: Bradley Scott Denney, Irvine, CA (US)

(21) Appl. No.: 19/177,236

(22) Filed: Apr. 11, 2025

Related U.S. Application Data
(60) Provisional application No. 63/634,668, filed on Apr. 16, 2024.

(51) Int. Cl. G06F 9/451

(52) U.S. Cl. CPC G06F 9/451

(57) ABSTRACT

According to the present disclosure, a method and apparatus for automatically laying out buttons in a user interface corresponding to regions in a provided template includes obtaining a template, determining connected regions in the template to be associated with a set of user actions, determining locations of user interface buttons to be shown to the user for each respective connected region, associating the user interface buttons with a set of user actions, drawing the user interface buttons over the template as a user interface, and rendering the user interface.

### CROSS-REFERENCE TO RELATED APPLICATIONS

This application is a continuation of U.S. Provisional Patent Application No. 63/634,668 filed Apr. 16, 2024, all of which is hereby incorporated by reference herein in its entirety.

### BACKGROUND

### Field

The present disclosure relates generally to the automation of a user interface layout based on a user provided template.

### Description of Related Art

Many software applications provide methods for users to layout content in an ad hoc manner. To facilitate this, the user interfaces of some applications allow users to use templates to follow for the layout of certain elements. For example, in a video broadcasting/streaming application, the user may wish to layout video feeds, images, text, data, screen shares, etc, into a single video stream. Some users, wishing to stylize their content, may choose to use templates providing frames/borders around the regions where content should be placed.

### SUMMARY

According to the present disclosure, a method and apparatus for automatically laying out buttons in a user interface corresponding to regions in a provided template includes obtaining a template, determining connected regions in the template to be associated with a set of user actions, determining locations of user interface buttons to be shown to the user for each respective connected region, associating the user interface buttons with a set of user actions, drawing the user interface buttons over the template as a user interface, and rendering the user interface.

In other embodiments, the determination of connected regions is based on a similarity of connected pixels in the template and the similarity is computed across a plurality of image frames in an animated sequence, and/or is based on whether the pixel has an alpha channel that is non-opaque, and/or is based on a gradient magnitude below a threshold.

In other embodiments, the determination of the location of the user interface buttons comprises determining the respective detected region's medial set and the determination of the location of the user interface buttons further comprises calculating a medoid of the respective a medial set.

In another embodiment, the determination of the location of the user interface buttons is based at least in part on the determination of an ideal location of the user interface buttons with respect to the respective region and the location of the other user interface button locations and/or wherein the determination of the location of the user interface buttons further comprises determining an attractive force of each button to the respective ideal button location and a set of repulsive forces between each button and every other button.

In a further embodiment, the attractive force between a button and the button's respective ideal location is proportional to the distance between the button and its respective ideal location and the force is in the direction of the respective ideal button from the button and/or the repulsive forces between a first button and a second button is equal to zero if the distance between the two buttons is greater than a threshold or equal to the threshold minus the distance between the two buttons otherwise and the force is in the direction from the second button towards the first button.

In other embodiments, the button locations are calculated iteratively and, in certain instances, random perturbations are added to the button locations during the iteration. Additionally, the action associated with a button includes adding an image source from one of the following: a video source, an image source, a screen share source, a template source, an overlay source, or an animation source.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWING FIGURES

The accompanying drawings, which are incorporated herein and form part of the specification, illustrate various embodiments, objects, features, and advantages of the present disclosure.

FIG. 1 illustrates a user interface display 100 that is selectively displayed on a display device according to the present disclosure.

FIG. 2 illustrates various regions of the user interface of FIG. 1 according to the present disclosure.

FIG. 3 illustrates exemplary operations of a digital force application processor according to the present disclosure.

FIG. 4 is an exemplary automatic layout generation mechanism according to the present disclosure.

FIG. 5 is an exemplary user interface generated using the automatic layout generation mechanism.

FIG. 6 is an exemplary control algorithm according the present disclosure.

FIG. 7 is a block diagram of the hardware on which the control algorithm according to the present disclosure is executed.

FIG. 8 is an exemplary automatic layout generation mechanism according to the present disclosure.

FIG. 9 is an exemplary user interface generated using the automatic layout generation mechanism.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

The present disclosure describes systems and methods for automatically modifying a user interface display containing a number of regions that is generated based on at least one template having a predetermined number of regions at one or more predetermined locations in which various content sources can be displayed. More specifically, the present disclosure automatically ensures that image elements enabling assignment of content to the one or more predetermined regions are visibly distinct from one another and that those elements clearly are associated with respective ones of the one or more regions. This advantageously assists the user through UI elements in the layout of their content that is consistent with one or more provided templates and further ensures that desired contents is associated with and displayed within the desired region within the template.

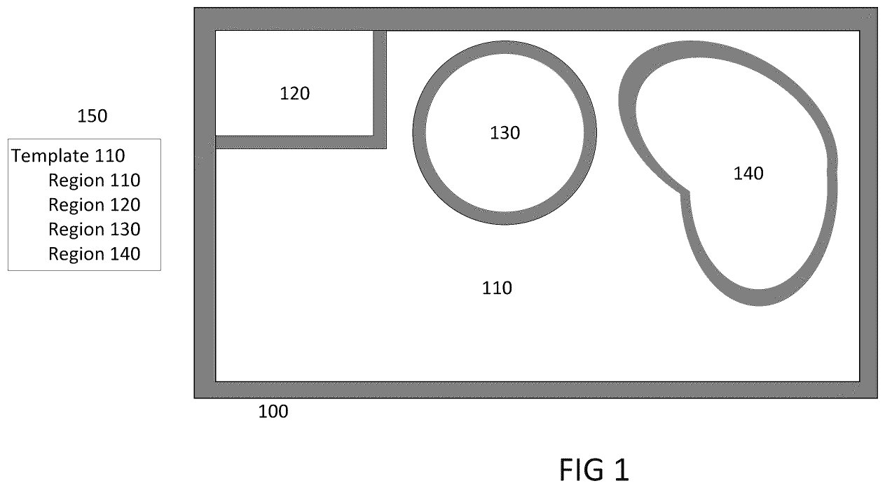

To better understand this principles of this disclosure we turn our attention to FIG. 1. FIG. 1 illustrates a user interface display 100 that is selectively displayed on a display device (e.g. screen, monitor, etc). In exemplary application a content sharing application (e.g. video streaming application) generates a user interface for display. In one embodiment, the content sharing application includes one or more layout templates that are used as part of the content sharing application whereby one or more content regions 110, 120, 130, 140 are selectively located at predetermined pixel locations within the user interface. The content sharing application aggregates a plurality of content sources such as live video image sources, pre-recorded video image sources, still image source, external application sources (e.g. chat application) that can be positioned in respective ones of the one or more content regions. In FIG. 1 a layout template 100 is provided that defines 4 regions appropriate for content insertion. Region 110 is the main window and spans most of the template area. Region 120 is a “picture in picture” type region in the top left. Region 130 is a circular region, and Region 140 is an arbitrarily shaped region for content insertion. In one embodiment these regions are enumerated and listed in a list style UI element 150 showing the template containing 4 child regions. The user may choose options for each region to insert/associate content with the region. Additionally, the UI may change the appearance of one or more pixels representing boundaries of the one or more regions to effectively highlight the region area or bounding rectangle associated with the selected region to assist the user in understanding the region they are interacting with.

In some embodiments, it is desirable, for example when the selector within the user interface (e.g. mouse) hovers over the displayed template, to show buttons in the region to perform certain actions. For example, when the user hovers over a region or over the template, the available regions may show buttons to add an image or a video source to be inserted and associated with the respective region. While this description considers a selector being controllable by a user input device such as a mouse, this is merely for purposes of example only. It should be understood that the UI being displayed may be displayed on a touch sensitive display device thereby enabling a user to provide touch input to a screen and control the selector within the user interface. In other embodiments, the content sharing application executing on a touch sensitive display apparatus can detect the touch input of a user on the display and highlight the region corresponding with the detected touch position.

However, when the regions are provided in arbitrary locations and when the regions can overlap with respect to their bounding rectangles, it can be challenging to place the buttons in locations that are intuitively associated with their respective regions. We would prefer that the buttons are in their respective regions and that they are generally central to the region, while at the same time, we would prefer that there is sufficient separation of the buttons.

For these reasons, some embodiments first calculate an ideal button location which only considers the region with which the button is associated. If these buttons were sufficiently distance from each other, the button locations could be used “as is”. In some embodiments, the center of the region bounding box is used as the “ideal button location”. In other embodiments, a point most central to the region is used as the ideal button location. For example, the medial points maximally distant from the region boundary (the boundary points are the set of points not inside the region, e.g., outside all regions, or in another region) may be used as candidate ideal locations. If the set contains more than one element, then the medoid of the set may be used. If more than one point could satisfy the condition of medoid, then one of these points may be arbitrarily chosen in some embodiments.

Regions may be detected via a variety of methods. As an example, the regions may be determined by detecting pixels in a template that are partially or completely transparent. A pixel may be determined to be part of a region if the pixel is transparent and the pixel neighbors another pixel already assigned to the region. If the pixel is transparent and not connected to an already existing region, a new region may be added to the region list and more pixels may be examined. In some cases, a pixel is transparent and may neighbor more than one region. In this case, the regions may be merged into a single region.

Once a set of connected (via pixel transparency) regions are determined, the region list may be pruned to remove undesirable regions. Undesirable regions may be regions where the region makes up too small of a percentage of the total pixels falling in the bounding rectangle of the region, the aspect ratio of the region is unusually large or small, the number of total pixels in the region is too low, or the region's width or height are too low, as a few examples of undesirable regions.

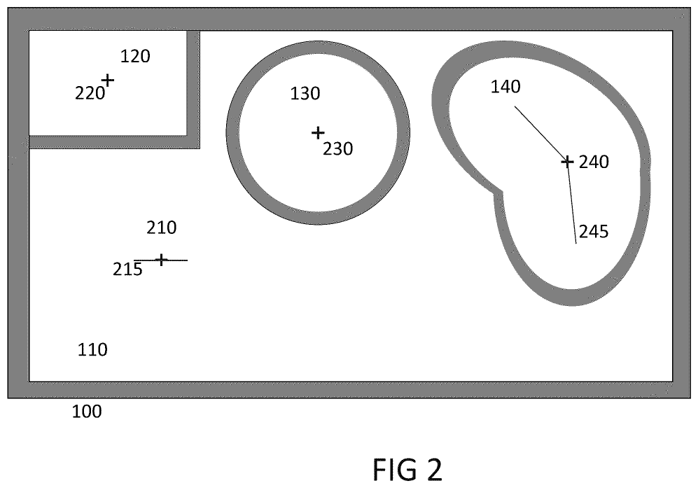

FIG. 2 shows the regions in FIG. 1: Regions 110, 120, 130, and 140. Additionally ideal button locations are shown 210, 220, 230, and 240 respectively. In the example of FIG. 2 region 110 has a set of points on the line 215 that are maximally distant from the borders of the region and the point 210 is the medoid of the set. The medoid, is the point whose sum of distances to all other points in the set is minimal. As another example, point 230 is in the medial set, however, since the shape is a circle there is only one point (the center) that is in the medial set. In region 140, the line 245 shows the regions medial set and the point 240 is the medoid of that set of points.

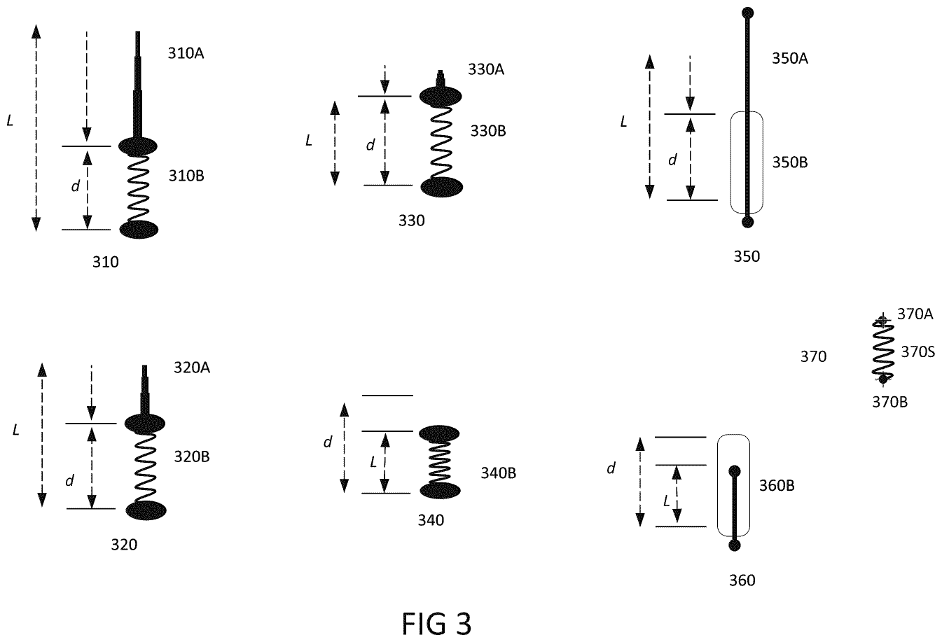

In some embodiments a system of digital force application processors are used to generate attractive and repulsive positioning operations representing forces that will impact the image element (e.g. user selectable button) locations within the user interface to cause one or more image elements to be located at a location other than their ideal locations but also ensures that it is clear that a respective image element is visually associated with a respective regions. In order to more easily describe the systems and methods, we use the analogy of physical spring-based devices which have been used as the basis for modeling the behavior of the digital force application processor. These are illustrated in FIG. 3.

In FIG. 3 a system of a telescoping rod connected to a compressive spring is shown in 310, 320, 330, 340, and then is shown generically as a unit in 350 and 360. The mechanism of action for the system is that the system is made up of two components: a telescoping linkage, and a compressive spring. While the digital force application processors may not use actual mechanical mechanisms, the digital system may produce a UI layout that mimics a physical system made of springs and telescoping rods. This will be described further below.

For example, 310 comprises a telescoping rod 310A and a compressive spring 310B. The telescoping rod can take on any length from zero to an arbitrarily large length. The rod can freely move without resistance. A compressive spring, for example in 310B, provides no force when in its natural resting position of length d. However, if the spring is compressed to a size smaller than d then the spring causes a force pushing back in the direction of compression linearly proportional to the displacement from the resting position (displacement of d). Thus, the overall linkage system of length L will provide a force between the bottom and top of the system of

$${F}_{repulse} = \{ \begin{matrix}{k}_{r} ( d − L ) \frac{w}{L} , & L < d \\ 0 , & L \geq d\end{matrix}$$

where kᵣ is the associated digital spring constant, a value chosen to represent the strength of repulsive force associated with the compressed displacement away from the distance d, w is the vector connecting the button to a second button. In this equation, L=∥w∥ is the separation of the two buttons.

In FIG. 3, the systems 310, 320, and 330 provide a force between linked points of 0, and the system in 340 provides a force pushing the linked points apart. For example, in 310, the separation of the two button locations, L, is greater than d, thus the repulsive force between the two buttons is 0 according to the above equation. In terms of the digital spring concept, at button separation distances greater than d, the telescoping component of the system exerts no force on the buttons. In 320, the distance between the buttons is shortened but still greater than d. Thus, this configuration of the system still does not exert any repulsive forces on the two buttons. In the case of 330, the distance between the buttons is exactly d. In this case the L=d, and the above equation still evaluates to zero and therefore there is not repulsive force. However, in 340, the distance L, becomes smaller than d and a force of proportional to the difference between d and L is applied repelling the two buttons from each other in directions opposite to the vector connecting the two buttons.

Also in FIG. 3, the system is represented more abstractly as a linking unit with a surrounding curved rectangle of the natural length d. 350 shows an abstract linkage applying zero force while 360 shows a force applying linkage.

FIG. 3 also shows a second type of linkage element: a spring 370 which connects points 370A and 370B via spring 370S. This spring provides an attractive force between the two points which is linearly proportional to the displacement of the two points. Mathematically, for the points separated by a distance of L the attractive force is given by

$${F}_{attract} = - {k}_{a} v$$

where kₐ is the associated spring constant, and v is the vector in the direction from the button location to the ideal location, and L is the magnitude of v. While the figure shows mechanical elements, it should be recognized that these are digital elements that are more easily illustrated via mechanical equivalents. Here 370 illustrates the attractive nature of a button location to its ideal location. Thus, any movement of the button away from the ideal location creates a force component on the button that pulls the button towards its ideal location. Overall, buttons may be subjected to a force pulling them towards their ideal location and potentially forces pushing the button away from nearby buttons. The resulting effect is a digital system that uses both repulsive and attractive forces to guide the location of the button to a point that considers all the buttons and regions when computing a button layout on a user interface.

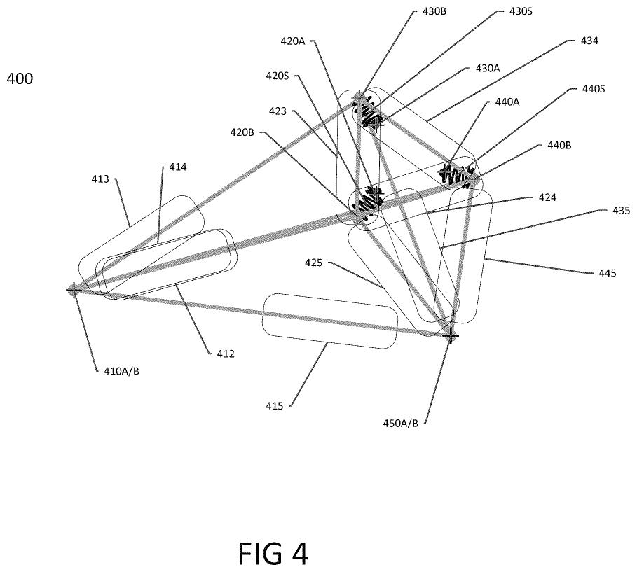

The mechanisms described in FIG. 3 are for illustrative purposes to describe an embodiment of determining an automatic layout of the UI buttons based on detected regions. An example of such a system is shown in FIG. 4. In FIG. 4, five button locations are described by their ideal locations 410A, 420A, 430A, 440A, and 450A, and by their respective adjusted locations 410B, 420B, 430B, 440B, and 450B. The adjusted buttons are all linked to each other via 5 choose 2 repulsion linkage mechanisms (10 mechanisms), 412 (between 410B and 420B), 413 (between 410B and 430B), 414 (between 410B and 440B), 415 (between 410B and 450B), 423 (between 420B and 430B), 424 (between 420B and 440B), 425 (between 420B and 450B), 434 (between 430B and 440B), 435 (between 430B and 450B), and 445 (between 440B and 450B). Each of the 5 button also has an attraction spring mechanism. In FIG. 4 the attraction springs 420S, 430S, and 440S are shown for three of the buttons that are moved (adjusted) from their ideal locations. Not shown are 410S and 450S since the ideal buttons 410A and 450A are at the same position as their respective adjusted button locations 410B and 450B.

In this example, we can see that the corresponding button 420B location is moved from its ideal location 420A because the repulsive mechanisms of 423 and 424 are exerting a force on 420B while at the same time, an attractive force due to the spring 420S is applying a force towards the ideal location. 420B is at an equilibrium where the forces are equal and opposite. A similar effect is seen on buttons 430B and 440B. Thus, the digital system considers both ideal button locations and the spacing of the buttons and attempts to find a balanced trade off between both location and spacing.

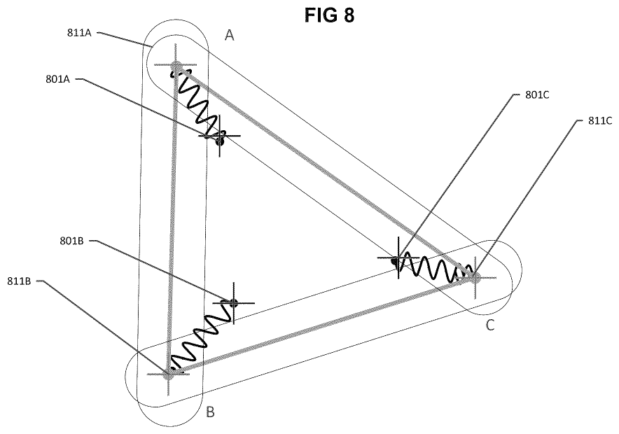

A second example is shown in FIG. 8. In this example 3 buttons, A, B, and C have respective ideal locations 801A, 801B, and 801C. In this example the 3 buttons are closer to each other than the distance threshold d. For this reason, button A experiences a repulsive force away from button C and button B. As button A is pushed outward, the attractive force to its ideal location increases. Similarly, buttons B and C experience similar respective forces. The result is an outward expansion of the button locations so that they have sufficient space between them at the expense of not occurring at their ideal locations.

More generally, this embodiment can be described for any number, N, of region buttons. Let us define the actual i-th button locations as aᵢ=(a_{i,x}, a_{i,y}) and the ideal button locations as bᵢ=(b_{i,x}, b_{i,y}) then we may calculate the forces on N buttons. The total force on each button is

$${F}_{i , total} = {F}_{i , a t t r a c t} + {F}_{i , repulse} = - {k}_{a} {v}_{i ,} + {\sum }_{j = 1 , j \neq i}^{N} \{ \begin{matrix}{k}_{r} ( d − {L}_{i , j} ) \frac{{w}_{i , j}}{{L}_{i , j}} , & {L}_{i , j} < d \\ 0 , & {L}_{i , j} \geq d\end{matrix}$$

Since the forces must all counteract each other at each button, the total force above should equal zero when the system is in an equilibrium state. In this equation

$${v}_{i} = {a}_{i} - {b}_{i}$$

$${w}_{i , j} = {a}_{i} - {a}_{j}$$

$${L}_{i , j} = \sqrt{{( {a}_{i , x} - {b}_{i , x} )}^{2} + {( {a}_{i , y} - {b}_{i , y} )}^{2}}$$

Some embodiments use a different function for the repulsive force which is differentiable everywhere. For example, a softplus function, scaled by a parameter α, may be used such that:

$${F}_{repulse} = log ( 1 + {e}^{a ( d - L )} ) \frac{w}{L}$$

Thus in this embodiment

$${F}_{i , total} = {F}_{i , a t t r a c t} + {F}_{i , repulse} = - {k}_{a} {v}_{i} + {\sum }_{j = 1 , j \neq i}^{N} log [ 1 + {e}^{a ( d - {L}_{i , j} )} ] \frac{{w}_{i , j}}{{L}_{i , j}}$$

In this case the actual button locations may be solved by setting F_{i,total} to zero for all N buttons and finding the actual button locations solving this system of equations.

In some embodiments the above system of force equations are not readily solvable directly, but rather in an iterative fashion. For, example, if the system is not in an equilibrium state, the residual forces may act on each actual button location to provide clues about directions and amounts the buttons may move to reduce the total force exerted on all of the elements in the system. For example, consider the following objective function

$$J = {\sum }_{i = 1}^{N} {‖ {F}_{i , total} ‖}^{2}$$

This objective function seeks to measure the total magnitude-squared of all button forces. This objective may be minimized iteratively until the button locations settle to a minima of the system. In some cases, small perturbations of the system may be made to prevent the system from settling into a local minima due to some region alignments and positions. For example colinear buttons may have difficulty re-arranging themselves past each other due to repulsive forces with the addition of these small perturbations which will allow forces to move the buttons around each other.

The parameter d described above (the telescoping linkage resting spring length) may be set as a fixed value or as a function of the number of regions in the system. For example, some embodiments may set d proportional to N or proportional to the square root of N or some other function of N. In this way if there are many regions, we may tolerate buttons being closer together in order to accommodate the higher number of regions, whereas if there are only a few regions, we may design the function parameter such that it prefers more spacing between the buttons.

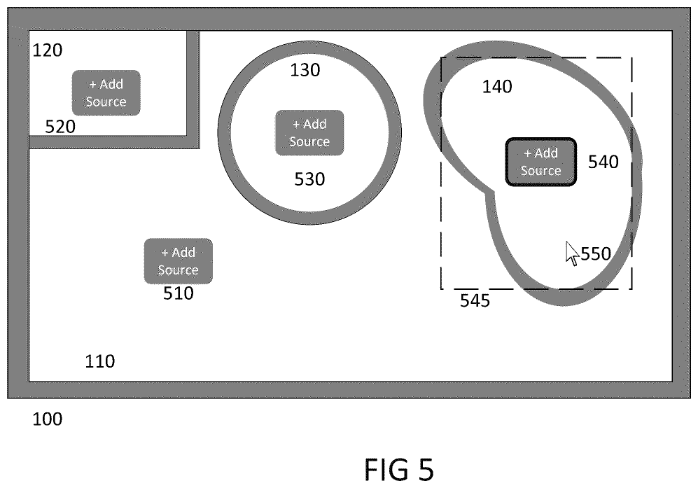

Once the actual button locations have been determined, the buttons may be shown on the UI. FIG. 5 shows an example UI where the template of FIG. 1 and FIG. 2 is shown with buttons in each region. Region 110 shows a button 510, region 120 shows a button 520, region 130 has a button 530, region 140 has a button 540. Additionally in this embodiment, as the mouse cursor 550 is hovering over region 540 a bounding rectangle 545 is shown along with a highlighted state of button 540 to illustrate to the user that by clicking the “+Add Source” button 540, the source selected to be added will be placed in the region and will be scaled to fit the rectangular highlight 545 but only pixels falling within the region 140 will actually be shown from the source selected by the user.

In some embodiments, the button may fall outside of the UI window boundary or near the boundary. These embodiments, the ideal location may be modified to be inside the boundary and a distance of d from the edge of the boundary. For example if the boundary coordinates of the UI is from a coordinate of (0.0, 0.0) as the top left corner and (1.0, 1.0) as the bottom right corner, then the ideal location of (x,y) can be updated to be

$$( {x}^{′} , {y}^{′} ) = min ( max ( d , x ) , 1. - d ) , min ( max ( d , y ) , 1. - d ) ) .$$

An alternative is to make the edge repulsive to the button location at the closest edge point to the button location. In this case, a force will be applied when the button approaches the boundary of the UI window.

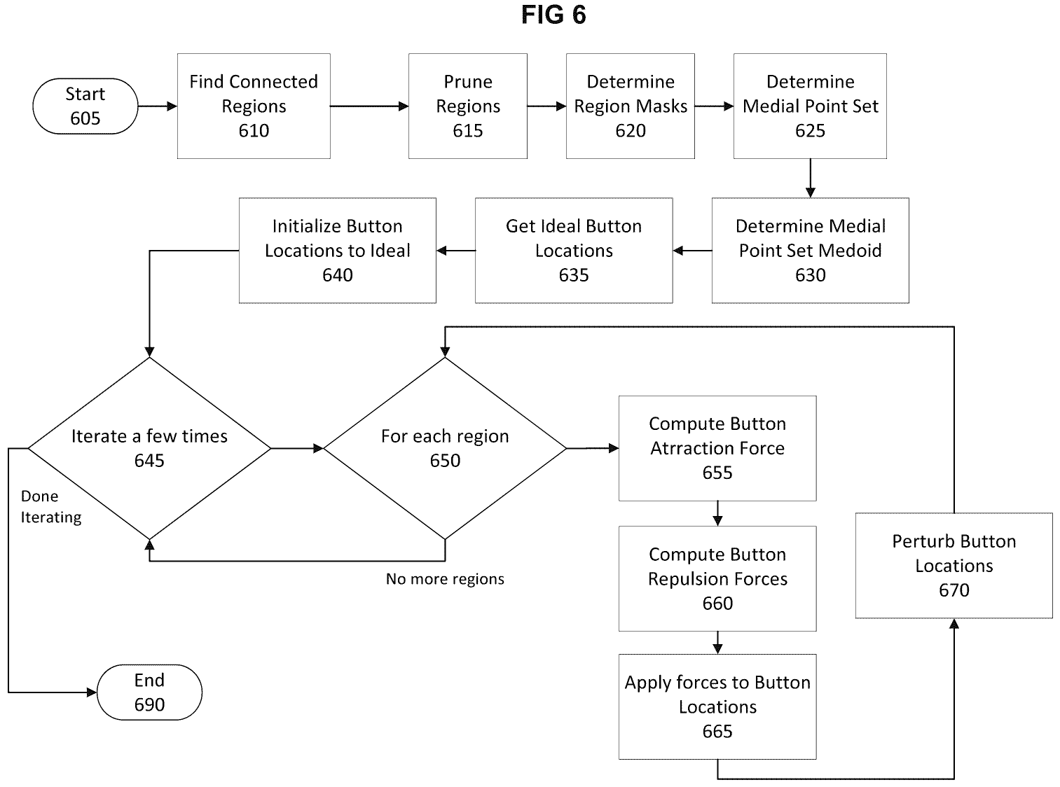

The overall flow for the automated layout of the UI is shown for one embodiment in FIG. 6. In this embodiment an iterative approach for finding the button locations is outlined. Flow starts in block 605 and moves to block 610. In block 610 the system finds the connected regions. As previously explained, the connected regions can be determined by a variety of methods.

One method finds connected regions of transparent pixels. Other methods may find regions where the change in pixel value doesn't vary greatly from one pixel to the next. For example, a background region with a small color or grayscale gradient may be considered to be connected, as long as the magnitude of the change from one pixel to the next doesn't exceed some threshold.

Other embodiments may work on templates which are animated. In this case connectivity of the regions may be considered using a single frame of the animation, or conversely, may be determined by considering the plurality of frames. As an example, a pixel may be said to be of a transparent state if it has an alpha value less than 255 for any frame in the animation sequence at that location. In this way transient effects may be rendered in some frames without destroying the concept of connected pixels for a region.

Other embodiments use AI techniques to determine the connected regions. For example, a deep learning algorithm may learn appropriate regions for the addition of user source inputs based on a labeled training set of templates with identified regions.

Moving to block 615, as explained previously, the set of candidate regions may be pruned to eliminate regions found in block 610 that may have undesirable qualities (e.g. too small, or unfavorable aspect ratio, etc.). Flow then moves to block 620 and region masks are determined. The region masks identify the pixels that are part of the region and pixels that are not. These masks may be used by the rendering engine to ensure that the source input is rendered to the appropriate locations in the composed output using the template.

The flow continues to block 625 where a medial point set is determined for each region found in 615. The medial point set is a set of one or more points that are maximally distant from a non-region pixel. In other words, a pixel's distance to a non-region pixel could be defined as the shortest distance to a non-region pixel, or the Manhattan distance to a non-region pixels. Some embodiments use a grassfire transform to find the Manhattan distance for each region. In some cases, a single grassfire transform may be used across all of the regions simultaneously by determining connectivity according to which region a pixel belongs and which region its neighbors belong. The maximum values of the grassfire transform for each region may be kept as the transform is being constructed and a list of the pixels with the maximum value may be constructed at that time.

Consider a region map array where the region index for the pixel (i,j) is given by r_{i,j}. When a pixel is not in a designated region the index is set to −1. Otherwise, the region index is used: 0, 1, 2, . . . , N−1. The following algorithm may be used.

### Algorithm: Medial Set:

1) Create an 2-D array for the grassfire transform values G_{i,j} and initialize the values to zero The grassfire calculates the Manhattan distance from each point to region boundary. The transform can be described as setting fire to the borders of a region and the time it takes for each pixel to be burnt is capture via the transform so that the pixels that took the longest are the regions medial point(s).
2) Create an array for the maximum grassfire transform values for each region Mk and initialize to zero

| | |
|---|---|
| 3) | For j in {1, ..., Height} |

| | |
|---|---|
| a) | For i in {1, ..., Width} |

| | |
|---|---|
| i) | If r_{i,j} ≥ 0 |

| | |
|---|---|
| (1) | If i > 0 and r_{i,j}==r_{i-1,j} |

| | |
|---|---|
| (a) | G_{i,j} = 1 + G_{i-1,j} |

| | |
|---|---|
| (2) | If j > 0 and r_{i,j}==r_{i,j-1} |

| | |
|---|---|
| (a) | G_{i,j} = min(G_{i,j}, 1 + G_{i,j-1}) |

| | |
|---|---|
| 4) | For j in {1, ..., Height} |

| | |
|---|---|
| a) | For i in {1, ..., Width} |

| | |
|---|---|
| i) | If r_{i,j} ≥ 0 |

| | |
|---|---|
| (1) | If i < Width and r_{i,j}==r_{i+1,j} |

| | |
|---|---|
| (a) | G_{i,j} = min(G_{i,j}, 1 + G_{i+1,j}) |

| | |
|---|---|
| (2) | If j < Height and r_{i,j}==r_{i,j+1} |

| | |
|---|---|
| (a) | G_{i,j} = min(G_{i,j}, 1 + G_{i,j+1}) |
| (b) | Mᵣ_{_{i,j}} = max(Mᵣ_{_{i,j}}, G_{i,j}) |

5) Create the medial point lists Lₖ for each region k from 0 to N−1 and initialize to empty lists.

| | |
|---|---|
| 6) | For j in {1, ..., Height} |

| | |
|---|---|
| i) | For i in {1, ..., Width} |

| | |
|---|---|
| (1) | If r_{i,j} ≥ 0 and G_{i,j} == Mᵣ_{_{i,j}} |

| | |
|---|---|
| (a) | Add point (i,j) to list Lᵣ_{_{i,j}} |

| | |
|---|---|
| 7) | Output lists Lₖ for each region k from 0 to N−1 |

Next in FIG. 6 flow moves to block 630 where the medial point sets are used to find a medoid point. The medoid point is the point in the set Lₖ which is most central to the set. One potential algorithm to find the medoid point of a set of points is outlined as follows. The mediod point represents the central most point in the set of medial points detected by the grassfire algorithm above. In situations when the grassfire transform determines that multiple points are equally distant from the region boundaries, we need to choose a single point among these multiple points to be the ideal button location. Here the mediod point is chosen as the ideal button location.

ALGORITHM: MEDOID

```
1) Set the minimum sum, m to infinity
2) For each point a in the set L
  a) Set sum s to zero
  b) For each point b in the set L
      $i ) s = s + \sqrt{{( {a}_{x} - {b}_{x} )}^{2} + {( {a}_{y} - {b}_{y} )}^{2}}$
  c) If s < m
      i) Set medoid point p to a
      ii) Set minimum m to s
3) Output the medoid point p
```

We notice that even with the above algorithm there may be more than 1 valid medoid points (e.g. if step 2-c uses a less than or equal instead of less than a different result-yet equally valid result could still be obtained). In this case additional strategies may be used to select a medoid point. For example, we may pick the point most distant from the nearest region bounding box center. Other embodiments may select the point at random from this set. Yet other may use a different strategy.

Additional embodiments may allow all medial points to be used wherein, the actual ideal button location is chosen from the set of medial points that experience the smallest net force from the other buttons. This is analogous to considering the medial points as a rail along which the ideal button location can freely move without resistance.

Next in FIG. 6 flow continues to block 635 where the ideal button locations are obtained. In some cases, these are simply the medial point set medoids as described above. In block 640 the actual button locations are initialized to the ideal button locations. In the embodiments described above, the telescoping linkage mechanisms may never reach their threshold to exert a force on the button locations. This can happen when the ideal button locations are sufficiently spaced apart from each other. In this case, the actual button locations may remain in their ideal positions and these position may be used in the user interface.

However, in cases where some buttons are too close to each other, the spring-based system may exert forces on the buttons such that the actual button locations may tend to move away from their ideal locations. To solve for the actual button locations, the flow continues to block 645 where the system iterates towards a solution. In each iteration, the flow moves to block 650.

Block 650 cycles through each region. For each region flow moves to block 655 where the attractive force is calculated. This force pulls each actual button towards their ideal location in a strength proportional with the distance between the actual and ideal location. For example, if the button is in its ideal position there is no attractive force acting on the actual button.

Flow then moves to block 660 where repulsive forces on the actual button are computed with respect to the other actual button locations. As described earlier, the telescoping repulsive mechanism may only exert a repulsive force away from the other buttons when the actual button is in close proximity to another actual button.

Next in block 665 the sum of all forces on the actual button is calculated and the actual button is moved by a small step proportional to the force vector calculated for the actual button. This force and step will move the button towards a better actual location such that the net forces decrease in magnitude on that button.

Optionally block 670 applies a small random perturbation on the button location. This perturbation may allow buttons that are co-linear (for example) to eventually move around each other to rearrange in a way that minimizes the total residual forces in the system.

Flow then returns to block 650 where the next region button is processed. If all regions have been processed flow then returns to block 645. Block 645 may continue iterating by proceeding to block 650 where all of the buttons are updated again, or block 645 may decide to stop iterating and proceed to block 690. The decision to stop iterating may be based on a threshold on the motion of the buttons from the previous iterations. For example, if the button locations stop moving, then it may be assumed that the system has reached an equilibrium or is close to an equilibrium. Some embodiments simply iterate for a fixed number of steps.

Finally in block 690 the computation for the actual button locations end and the locations are returned to the user interface to be shown as was illustrate in FIG. 5 for example.

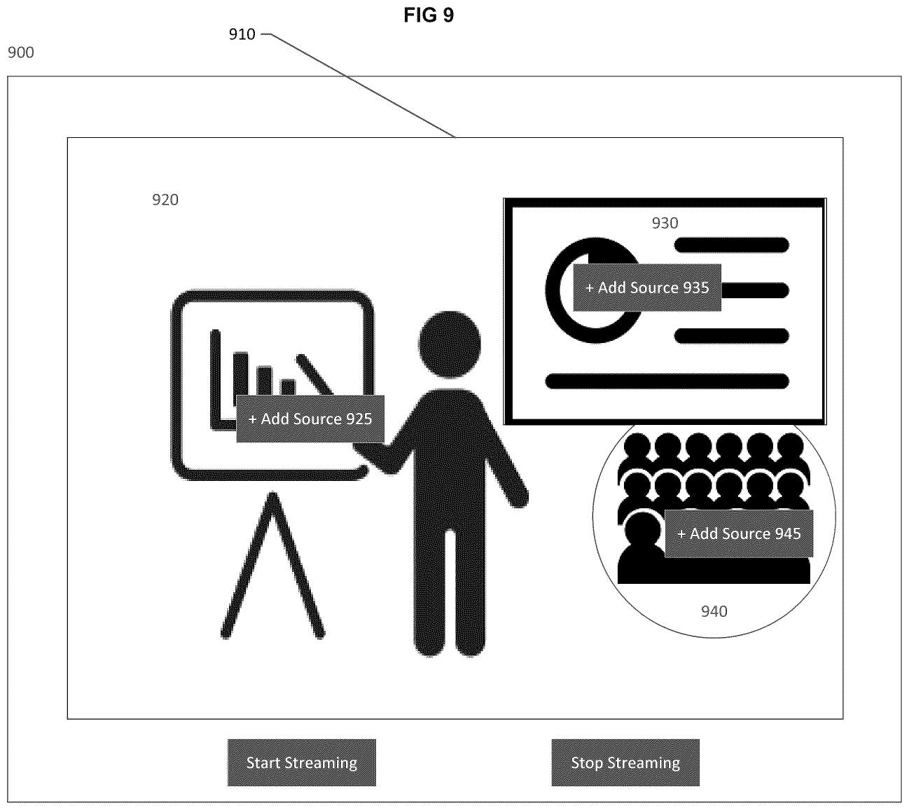

FIG. 9 shows a video streaming app UI 900 where the user may use a template to facilitate the layout of the video content to be shown. Here the UI shows the template 910 with 3 regions 920, 930, and 940. Each video region may be populated by the user by clicking the respective region button 925, 935, 945. In the example shown, region 920 is showing the users video, region 930 is showing presentation slides, and region 940 is showing video of an audience watching the presentation. The user may click on one of the buttons 925, 935, or 945 to add or change the content of the respective region. Additionally, the UI may have other controls to modify the video stream such as start streaming and stop streaming, or switch to a different template or content.

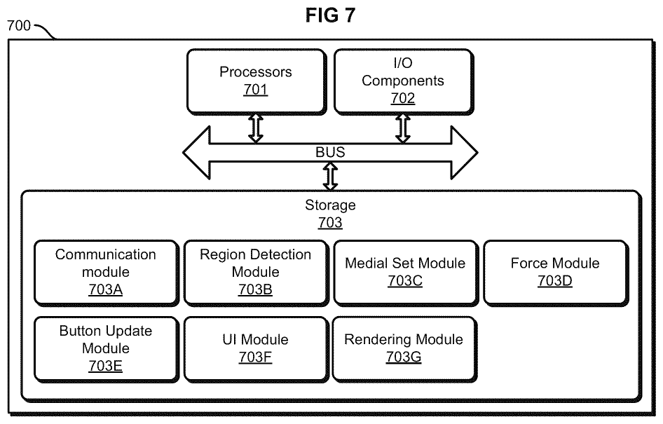

FIG. 7 illustrates the hardware of the information processing apparatus 700 which is selectively connected to a network such as a wired network, a wireless network, a LAN, a WAN, a MAN, and a PAN. Also, in some embodiments the devices communicate via other wired or wireless channels.

The information processing apparatus 700 includes one or more processors 701, one or more I/O components 702, and storage 703. Also, the hardware components communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 701 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 702 include communication components (e.g., a graphics card, a network-interface controller) that communicate with the display apparatus, the network and other input or output devices (not illustrated), which may include a keyboard, a mouse, a printing device, a touch screen, a light pen, an optical-storage device, a scanner, a microphone, a drive, and a game controller (e.g., a joystick, a gamepad).

The information processing apparatus includes modules 703A-703G in the storage 703 that performs the functions described hereinabove with respect to FIGS. 1-6. A module includes logic, computer-readable data, or computer-executable instructions. In the embodiment shown in FIG. 7, the modules are implemented in software (e.g., Assembly, C, C++, C#, Java, Javascript, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage.

The storage 703 includes one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 703, which may include both ROM and RAM, can store computer-readable data or computer-executable instructions.

The information processing apparatus, as shown herein, includes a communication module 703A in storage 703 that contains instructions that when executed are used to communicate via the network and to send images to a display device (such as those shown in FIG. 1 and FIG. 5, and receive inputs from a keyboard and mouse device.

The storage 703 also contains a Region Detection Module 703B which contains instructions that when executed carry out the functions described in blocks 610, 615, and 620 for FIG. 6.

The storage 703 also contains a Medial Set Module 703C that contains instructions that cause the information processing apparatus 700 to compute the medial set points for the regions detected by the Region Detection Module 703B and as describe by block 625 of FIG. 6 and as illustrate by 220, 230, 245, and 215 of FIG. 2. The Medial Set Module 703C may also contain instructions to calculate the Medoids of the medial sets detected as described by block 630 of FIG. 6 and as illustrated by 210, 220, 230, and 240 of FIG. 2.

The storage 703 also contains a Force Module 703D that calculates attractive and repulsive forces for buttons as illustrated by the example devices of FIG. 3 and by the linkage diagram for the example shown in FIG. 4. The Force Module contains instructions that when carried out perform the necessary calculations show in blocks 655 and 660 of FIG. 6.

Additionally, the storage 703 contains a Button Update Module 703E which contains instructions that when executed carry out the instructions of blocks 635, 640, 645, 650, 665, and 670 and 690 of FIG. 6. The Button Update Module 703E also calls on the instructions stored in the Force Module 703D to carry out force calculations. The Button Update Module also retrieves the initial button locations as illustrated in block 635 of FIG. 6 from the Medial Set Module 703C.

The storage includes a UI Module 703F which contains instructions to prepare the UI for viewing via the Rendering Module 703G which shows the UI template, shown in FIG. 5 as an example, along with input sources added to the template according to actions with the buttons as performed by a user. The UI Module also contains instructions to carry out actions associated with user input such as handling mouse over events and handling button interactions caused by the user.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for automatically laying out buttons in a user interface corresponding to regions in a provided template comprising:
obtaining a template;
determining connected regions in the template to be associated with a set of user actions;
determining locations of user interface buttons to be shown to the user for each respective connected region;
associating the user interface buttons with a set of user actions;
drawing the user interface buttons over the template as a user interface; and
rendering the user interface.

2. The method of claim 1 wherein the determination of connected regions is based on a similarity of connected pixels in the template.

3. The method of claim 2 wherein the similarity is computed across a plurality of image frames in an animated sequence.

4. The method of claim 2 wherein the similarity is based on whether the pixel has an alpha channel that is non-opaque.

5. The method of claim 2 wherein the similarity is based on a gradient magnitude below a threshold.

6. The method of claim 1 wherein the template is for livestreaming video content.

7. The method of claim 1 wherein the determination of the location of the user interface buttons comprises determining the respective detected region's medial set.

8. The method of claim 7 wherein the determination of the location of the user interface buttons further comprises calculating a medoid of the respective a medial set.

9. The method of claim 1 wherein the determination of the location of the user interface buttons is based at least in part on the determination of an ideal location of the user interface buttons with respect to the respective region and the location of the other user interface button locations.

10. The method of claim 9 wherein the determination of the location of the user interface buttons further comprises determining an attractive force of each button to the respective ideal button location and a set of repulsive forces between each button and every other button.

11. The method of claim 10 wherein the attractive force between a button and the button's respective ideal location is proportional to the distance between the button and its respective ideal location and the force is in the direction of the respective ideal button from the button.

12. The method of claim 11 wherein the repulsive forces between a first button and a second button is equal to zero if the distance between the two buttons is greater than a threshold or equal to the threshold minus the distance between the two buttons otherwise and the force is in the direction from the second button towards the first button.

13. The method of claim 1 wherein the button locations are calculated iteratively.

14. The method of claim 1 wherein the action associated with a button includes adding an image source from one of the following: a video source, an image source, a screen share source, a template source, an overlay source, or an animation source.

15. The method of claim 13 wherein random perturbations are added to the button locations during the iterations.

16. The method of claim 1 wherein the rendering of the user interface includes highlighting a region when the mouse is over the region.

17. The method of claim 1 wherein the rendering of the user interface includes highlighting a
button when the mouse is in the region corresponding to the respective button.

18. An apparatus that automatically lays out buttons in a user interface corresponding to regions
in a provided template comprising:
a display;
at least one memory storing instructions; and
at least one processor that, upon execution of the stored instructions, is configured to perform operations comprising:
obtaining a template;
determining connected regions in the template to be associated with a set of user actions;
determining locations of user interface buttons to be shown to the user for each respective connected region;
associating the user interface buttons with a set of user actions;
drawing the user interface buttons over the template as a user interface; and
rendering the user interface on the display.
